(19) United States
(12) Patent Application Publication
(10) Pub. No.: US 2008/0017321 A1
(43) Pub. Date: Jan. 24, 2008

(54) Method and device for high speed labeling of articles using two-sided labelstock

(76) Inventor: Tarquin Crouch, Southborough (GB)

Correspondence Address: ExxonMobil Chemical Company;Law Technology, P.O. Box 2149, Baytown, TX, 77522-2149, US

(21) Appl. No.: 11/787,566

(22) Filed: Apr. 17, 2007

Related U.S. Application Data
(62) Division of application No. 11/489,402, filed on Jul. 19, 2006.

(51) Int. Cl. B65C 9/26

(52) U.S. Cl. 156/391

(57) ABSTRACT

A method for high speed labeling of articles, including a two-sided roll of labelstock, a plurality of articles to be labeled and a high speed labeling device, is provided. The labels may be applied to articles in either a two-pass or a one-pass embodiment. The use of a two-sided roll of labelstock may have the advantage of reduced quantity of waste materials as well as reduced cost of transportation, waste disposal and changeovers.

### CROSS-REFERENCE TO RELATED APPLICATION

This is a divisional of U.S. co-pending application Ser. No. 11/489,402, filed Jul. 19, 2006, incorporated herein by reference in its entirety.

### FIELD OF THE INVENTION

This invention relates generally to an improved method for high speed labeling of articles wherein labels are extracted from both sides of a two-sided labelstock roll by a high speed labeling machine for application to a plurality of articles.

### BACKGROUND OF THE INVENTION

The application of labels to articles, products and packaging has been and continues to be an important step in providing product identification, specific production information and marketing advantages. Manufacturers of various products are continually seeking a more efficient and effective manner in which to apply labels to articles, products and packaging such as cartons, containers or any other packages or products having a surface capable of securely receiving an adhesive label.

Numerous methods have been employed in the past to label articles. The introduction of adhesive-backed pressure sensitive labels and high speed labeling machines has greatly facilitated the labeling of numerous articles at a high rate of speed.

Labeling methods commonly known in the art utilize traditional high speed labeling machines to apply labels to articles advancing by a labeling station on, for example, a conveyor belt. The pressure sensitive labels are commonly pre-cut and carded on one side of a continuous web of material, known as a “release liner”, which is wound onto a roll for mounting on the labeling machine.

High speed labeling machines are commonly known in the art. One example of such a machine utilizes labels that are attached to one side of a release liner that is somewhat more flexible than the label itself This allows the label to be separated from the release liner simply by bending the release liner sharply away from the label, which is usually done by drawing the release liner over a fairly sharp stripping or peeling edge of a peeling bar or plate, commonly known as a “beak”. The less flexible label then separates from the web material and remains relatively straight for application to an article by some type of high speed applicator process.

Another known type of high speed labeling machine also utilizes labels that are attached to only one side of a release liner. The labels are removed from the release liner by means of vacuum extraction and are then applied to an article by a bellows applicator.

It would be desirable to utilize a two-sided labelstock with a high speed labeling machine. However, current labelstocks and high speed labeling machine processes do not provide the option of extracting labels from a two-sided labelstock roll.

U.S. Pat. No. 5,133,827 to Ratermann (Hobart Corporation) discloses a method and apparatus for printing and applying labels to packages which may vary in height over a large range. Packages are sensed on a conveyor as they move toward a timed label applier designed to apply the label to a preferred area on the upper surface of the packages adjacent either the leading side edges or the trailing side edges of the package. Ratermann does not disclose the use of two-sided labelstock with a high speed labeling machine.

U.S. Pat. No. 4,624,734 to Voltmer et al. (New Jersey Machine, Inc.) discloses a label dispenser for applying labels to containers transported in a given direction of travel along a conveyer comprising a supply station providing a web with pressure sensitive labels disposed thereon, a dispensing head with a means for transferring labels from the web to individual containers and a guide assembly for guiding the web. However, Voltmer et al. do not reveal the use of a two-sided labelstock.

U.S. Pat. No. 5,472,552 to Speranza et al. (Exact Packaging Inc.) discloses a high speed labeling machine for dispensing labels from a continuous web of material and applying the labels to a plurality of articles moving relative to the labeling machine along a predetermined path comprising a supply means for the continuous web of material having the labels affixed thereto, a driving means for moving the web through the labeling machine, a movable dispensing means for receiving the web and removing a label for application to the article, and a positioning means for automatically moving the dispensing means to various positions. Speranza et al., also do not reveal the use of a two-sided labelstock.

PCT Publications WO 2005/084383 A2 and WO 02/077902 A1, both to Sinclair Systems International, disclose methods and apparatuses for supplying labels. WO 2005/084383 reveals an automatic labeling machine used to apply labels to agricultural produce. The labeling machine of this invention utilizes a sensing means for identification of the produce items and a laser coding means for producing a code on a label to be applied to the produce items. WO 02/077902 specifically discloses a high speed labeling machine and a computer based method for ordering and supplying coded labels for application at a plurality of labeling stations. Neither publication discloses the use of two-sided labelstock in a high speed labeling machine.

U.S. Pat. No. 4,896,793 to Briggs et al., assigned to Sinclair International Limited, together with EP Patent 0113256 B1, EP Patent 1429965 B1 and EP Patent 1163155 B1, all to Sinclair International Limited, disclose various labeling machines. Each of these labeling machines utilizes a vacuum extraction and application technique in labeling a plurality of items, most commonly agricultural produce. None of the listed patents disclose the use of a two-sided labelstock.

U.S. Pat. No. 5,727,817 to Kraige discloses a group of peel-off coupons adhered on both sides of a thin release liner or liners composed to allow for the removable adhesion of peel-off label stock, and scored so as to be foldable and stored in a protective cover. Kraige does not disclose the use of a two-sided labelstock in a high speed labeling machine.

U.S. Pat. No. 6,521,309 to Chen et al. discloses a double-sided, single liner, pressure sensitive adhesive tape. A layer of release material is disposed on one side of a release liner web and a fluorosilicone release material is disposed on the opposite surface of the release liner web. Chen, however, does not disclose a labelstock for use in a high speed labeling machine.

None of the disclosures described above combine the desired improvements in high speed labeling with a two-sided labelstock for some of today's challenging labeling operations. Opportunities exist in the art for a high speed labeling process wherein labels are provided on both sides of a labelstock roll for application to a plurality of articles. An important advantage of a two-sided labelstock used in high speed labeling is the reduced quantity of waste material, i.e., the release liner, which must be disposed of after removal of the labels. Significant cost savings are also realized as both sides of the release liner are utilized, thereby reducing the cost of the release liner alone by up to 50%. Transportation, waste disposal and changeover costs are also reduced. The present invention meets these and other needs.

### SUMMARY OF THE INVENTION

The present invention relates generally to a method and device for high speed labeling of articles using two-sided labelstock. In one embodiment, the inventive method comprises providing a roll of labelstock, the labelstock comprising a release liner-having a first side and a second side, and pressure sensitive adhesive labels releasably adhered to both the first side and second side of the release liner; providing a plurality of articles to be labeled; and using a high speed labeling machine to remove the pressure sensitive adhesive labels from the first side and the second side of the release liner and apply the labels to the articles.

In another embodiment, the invention generally relates to a method of labeling articles comprising providing a roll of labelstock, the labelstock comprising a release liner having a first side and a second side, and pressure sensitive adhesive labels releasably adhered to both the first side and the second side of the release liner; providing a plurality of articles to be labeled; using a high speed labeling machine to unroll the roll of labelstock, sequentially remove the pressure sensitive adhesive labels from the first side of the release liner as the roll of labelstock is being unrolled, and apply each of the labels from the first side of the release liner to a different one of the articles; reverse winding the roll of labelstock; and using the high speed labeling machine to unroll the reverse wound roll of labelstock, sequentially remove the pressure sensitive adhesive labels from the second side of the release liner as the reverse wound roll of labelstock is being unrolled, and apply each of the labels from the second side of the release liner to a different one of the articles.

In yet another embodiment, the invention generally relates to a method of labeling articles comprising providing a roll of labelstock, the labelstock comprising a release liner having a first side and a second side, and pressure sensitive adhesive labels releasably adhered to both the first side and the second side of the release liner; providing a plurality of articles to be labeled; using a high speed labeling machine comprising a first labeling station and a second labeling station to unroll the roll of labelstock, sequentially remove the pressure sensitive adhesive labels from the first side of the release liner as the roll of labelstock is being unrolled, sequentially remove the pressure sensitive adhesive labels from the second side of the release liner as the roll of labelstock is being unrolled, and apply the labels to the articles. According to a first variation of this embodiment, each of the pressure sensitive adhesive labels from both the first side of the release liner and the second side of the release liner is applied to a different one of the articles. Alternatively, according to another variation, each of the articles may receive one pressure sensitive adhesive label from the first side of the release liner at the first labeling station and one pressure sensitive adhesive label from the second side of the release liner at the second labeling station. According to still further variations of this embodiment, corresponding pressure sensitive adhesive labels may be removed from both sides of the release liner substantially simultaneously or, alternatively, the pressure sensitive adhesive labels may be removed from the first side of the release liner before the corresponding pressure sensitive adhesive labels are removed from the second side of the release liner.

In still another embodiment, the invention generally relates to a device for labeling articles comprising a label supply means for unwinding a roll of labelstock and feeding the labelstock through the device, the roll of labelstock comprising a release liner having a first side and a second side, and pressure sensitive adhesive labels releasably adhered to both the first side and the second side of the release liner; a first vacuum drum including means for removing the pressure sensitive adhesive labels from the first side of the release liner and applying the pressure sensitive adhesive labels to the articles and a second vacuum drum including means for removing the pressure sensitive adhesive labels from the second side of the release liner and applying the pressure sensitive adhesive labels to the articles. Optionally, the device may also include a release liner rewind means for rewinding the release liner after the release liner has passed through the device and the pressure sensitive adhesive labels have been removed from both sides of the release liner. Corresponding pressure sensitive adhesive labels may be removed from both sides of the release liner substantially simultaneously. Alternatively, pressure sensitive adhesive labels may be removed from the first side of the release liner before the corresponding pressure sensitive adhesive labels are removed from the second side of the release liner.

It is an object of the present invention, therefore, to overcome the disadvantages of the prior art and to provide a method capable of utilizing a two-sided labelstock and a high speed labeling machine to apply labels to a plurality of articles.

### BRIEF DESCRIPTION OF THE FIGURES

FIG. 1A is a schematic view of the first pass of a two-pass embodiment of the current invention.

FIG. 1B is a schematic view of the second pass of a two pass embodiment of the current invention.

FIG. 2 is a schematic view of a one-pass embodiment according to the current invention.

FIG. 3 is a perspective view of one embodiment of the high speed labeling device of the current invention.

### DETAILED DESCRIPTION OF THE INVENTION

Various specific embodiments, versions and examples of the invention will now be described, including definitions that are adopted herein for purposes of understanding the claimed invention. While the following detailed description gives specific preferred embodiments, those skilled in the art will appreciate that these embodiments are exemplary only, and that the invention can be practiced in other ways. For purposes of determining infringement, the scope of the invention will refer to the appended claims and elements or limitations that are equivalent to those that are recited. Any reference to the “invention” may refer to one or more, but not necessarily all, of the embodiments defined by the claims.

As used herein, “labelstock” is defined as a roll of material consisting of a multi-layer laminate suitable for labeling applications. The two-sided labelstock of the current invention consists of at least a release liner with a first side and a second side, a first pressure sensitive adhesive layer positioned adjacent to the first side of the release liner, a second pressure sensitive adhesive layer positioned adjacent to the second side of the release liner, a first facestock layer positioned adjacent to the first adhesive layer and a second facestock layer positioned adjacent to the second adhesive layer.

As used herein, “facestock” is defined as the printable surface layer located on each of the outward facing sides of the two-sided labelstock, defined above. According to the present invention, each facestock layer may itself comprise a single or multiple layers. The facestock is die-cut to a specified size and shape to form the labels that are ultimately applied to articles for purposes of product identification and marketing.

As used herein, “skeletal waste” is defined as the unused portion of the facestock and the pressure sensitive adhesive layer located between the labels following die-cutting, also known in the art as the “matrix”. The skeletal waste is removed from both sides of the two-sided labelstock surfaces and discarded prior to application of the labels to the articles.

As used herein, “corresponding” labels are defined as two opposing labels, one on the first side of the release liner and one on the second side of the release liner, that are located at the same distance along the length of the release liner.

As used herein, “polymer” may be used to refer to homopolymers, copolymers, interpolymers, terpolymers, etc.

We have discovered an improved method for high speed labeling of articles. The method according to this invention utilizes a two-sided labelstock comprising a release liner with pressure sensitive adhesive labels releasably adhered to both sides of the release liner and a high speed labeling machine.

### Labelstock

As is known to those skilled in the art, labelstock comprises a continuous web of material upon which pressure sensitive adhesive labels are disposed, typically at a uniform interval. One-sided labelstocks (i.e., labelstocks having pressure sensitive adhesive labels adhered to only one side of the continuous web) are commonly used in high speed labeling machine applications.

The two-sided labelstock used in connection with the present invention comprises at least five distinct layers, including a center release liner having a first side and a second side, a first pressure sensitive adhesive layer positioned adjacent to the first side of the release liner, a second pressure sensitive adhesive layer positioned adjacent to the second side of the release liner, a first facestock layer positioned adjacent to the first pressure sensitive adhesive layer and a second facestock layer positioned adjacent to the second adhesive layer.

The release liner of the multi-layer labelstock provides the foundation of the two-sided labelstock structure. The release liner of the present invention comprises a core layer having a first side and a second side, and two coating layers, one on each side of the core layer. The core layer may be any conventional flexible sheet material known in the art. As such, the core layer may, itself, comprise either a single or multiple layers. In preferred embodiments, the core layer of the present invention is a single-layer or multi-layer film selected from the group consisting of glassine, paper, poly-coated paper, oriented or cast polymers of polypropylene, polyethylene, polyethylene terephthalate, polyamide, polystyrene and the like.

The coating layers of the release liner are positioned adjacent to both the first side and second side of the core layer. The coating layers have low tack thereby permitting the ready release of materials, including pressure sensitive adhesive labels, which may be applied thereto. The release properties of the coating layers promote the release of all, if not substantially all, of the pressure sensitive adhesive(s) so that the adhesive(s) remains with the facestock when it is removed from the release liner. In preferred embodiments of this invention, the coating layers include a release agent selected from the group consisting of silicone, polyethylene, polypropylene, fluorocarbons and blends thereof

In some embodiments, the coating layer applied to the first side of the core layer is the same as the coating layer applied to the second side of the core layer. In other embodiments, the coating layer applied to the first side of the core layer is different from the coating layer applied to the second side of the core layer.

According to the current invention, the first pressure sensitive adhesive layer and second pressure sensitive adhesive layer comprise at least one pressure sensitive adhesive. When applied to both surfaces of the release liner, the pressure sensitive adhesive layers bond weakly to the release liner and strongly to the facestock, thus allowing for removal of the pressure sensitive adhesive labels for application by a high speed labeling machine.

In preferred embodiments of this invention, the pressure sensitive adhesive is selected from the group consisting of hot melt adhesives, water-based adhesives, solvent-based adhesives and rubber-based adhesives.

In some embodiments, the pressure sensitive adhesive of the first pressure sensitive adhesive layer is the same as the pressure sensitive adhesive of the second pressure sensitive adhesive layer. In other embodiments, the pressure sensitive adhesive of the first pressure sensitive adhesive layer is different from the pressure sensitive adhesive of the second pressure sensitive adhesive layer.

The first facestock layer and second facestock layer are the two outermost layers of the two-sided, multi-layer labelstock structure. The first facestock layer and second facestock layer are the printable surface layers which, together with the first pressure sensitive adhesive layer and the second pressure sensitive adhesive layer, respectively, are die-cut and stripped of skeletal waste to form the plurality of pressure sensitive adhesive labels which are releasably adhered to both sides of the two-sided release liner. The facestock layers of the present invention may comprise either a single or multiple layers.

In a preferred embodiment of this invention, the facestock layers are single-layer or multi-layer films selected from the group consisting of paper, metal foils, oriented or cast polymers of polypropylene, polyethylene, polyethylene terephthalate, polystyrene and the like.

The two-sided labelstock structure of this invention is die-cut on both sides with sufficient precision such that only the facestock layers and pressure sensitive adhesive layers are cut into a specified size and shape to form pressure sensitive adhesive labels, while the release liner remains intact.

After die-cutting, the facestock material surrounding the pressure sensitive adhesive labels on both sides of the two-sided labelstock, conmmonly known in the art as skeletal waste or matrix, is stripped away from the release liner, leaving the pressure sensitive adhesive labels releasably adhered to both sides of the two-sided labelstock. The skeletal waste is discarded after removal. The two-sided labelstock is then wound into a roll which can be mounted on a high speed labeling machine for application to a plurality of articles.

### Articles to be Labeled

The method and device of the current invention can be used for the application of pressure sensitive adhesive labels by a high speed labeling machine to a variety of articles including, but not limited to, bottles, jars, food trays, packaging sleeves, cartons, books, magazines, electrical equipment, building products, computer hardware and software, CDs, tapes, stationery, office products, furniture, furnishings, decorative articles, plants, gardening equipment, cleaning and washing products, health and beauty care products, clothing, automotive, aerospace and shipping parts and products, mechanical and machine parts, tools, camping, leisure, games and sports equipment, toys, hobby products, food products, boxes and other packaging materials.

### Two-Pass Embodiment

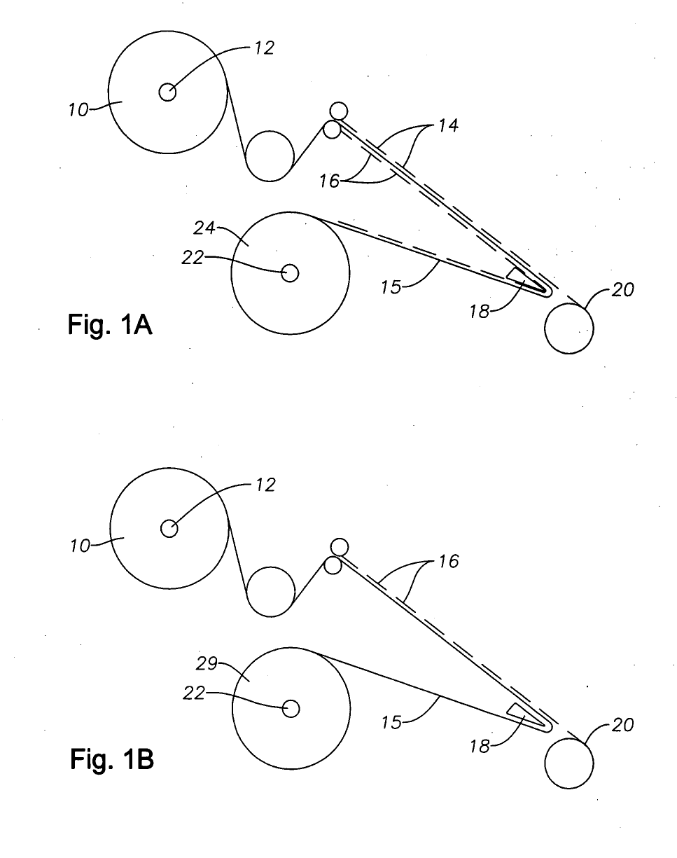

A schematic view of a two-pass embodiment of the method for labeling articles in accordance with the present invention is shown in FIG. 1A. In this embodiment, the method comprises the use of a roll of two-sided labelstock 10 mounted on a label supply means 12 which is rotatably mounted on a high speed labeling machine. The continuous web of two-sided labelstock 10 is fed through the high speed labeling machine toward a labeling station 20. The release liner material of the two-sided labelstock 10 is somewhat more flexible than the pressure sensitive adhesive labels on both sides thereof. As the two-sided labelstock 10 advances through the machine, the first side pressure sensitive adhesive labels 14 become separated from the release liner 15 by bending the release liner 15 sharply away from the first side pressure sensitive adhesive labels 14. A dispensing device, such as a beak 18, is positioned a spaced distance from the label supply means 12. The spaced distance between the label supply means 12 and the beak 18 may range from a few inches to many feet. Separation of the first side pressure sensitive adhesive labels 14 is achieved by drawing the two-sided labelstock 10 over the beak 18. The second side pressure sensitive adhesive labels 16 are forced to bend around the beak 18 by release liner 15. The end of the beak 18 should be sufficiently blunt so as to avoid damaging the second side pressure sensitive adhesive labels 16 as they pass over and around the end of the beak 18.

The less flexible first side pressure sensitive adhesive labels 14 then separate from the release liner 15 and remain relatively straight for application to a plurality of articles by some type of applicator, such as a brush applicator (not shown), at the labeling station 20, as would be well known to persons skilled in the art. Typically, the articles to be labeled are located on some form of conveyor or other handling device (not shown) that moves them through labeling station 20. The release liner 15 continues to unroll as it advances through the high speed labeling machine and the pressure sensitive adhesive labels are sequentially removed and applied to the articles by this method.

Upon passing over the end of the beak 18, the release liner 15 with the second side pressure sensitive adhesive labels 16 still intact on the second side of the release liner 15 proceeds toward the release liner rewind means 22 where the release liner 15 and the second side pressure sensitive adhesive labels 16 are reverse wound by the release liner rewind means 22 to form a reverse wound roll 24 of labelstock. As used herein, “reverse wound” means that the release liner 15 is rewound so that the second side, which was the inner side, becomes the outer side of the labelstock.

The reverse wound roll 24 is then manually removed from the release liner rewind means 22 and re-mounted on the label supply means 12, where the now one-sided labelstock is fed through a second pass on the high speed labeling machine, as schematically illustrated in FIG. 1B. The second side pressure sensitive adhesive labels 16 advance through the high speed labeling machine toward the labeling station 20. As before, the release liner material is passed over the beak 18 and the second side pressure sensitive adhesive labels 16 are separated from the release liner material by bending the release liner 15 sharply away from the second side pressure sensitive adhesive labels 16. The second side pressure sensitive adhesive labels 16 are then sequentially applied to a plurality of articles at a labeling station 20 as the labelstock is unrolled. The release liner 15, with both the first side pressure sensitive adhesive labels 14 and second side pressure sensitive adhesive labels 16 removed, proceeds toward a release liner rewind means 22 where the release liner 15 is wound onto a release liner roll 29 for convenient disposal. In an alternative embodiment of the second pass, not shown in FIG. 1B, the release liner 15 with both the first side pressure sensitive adhesive labels 14 and the second side pressure sensitive adhesive labels 16 removed may be shredded, spooled onto the floor or other surface, directed into a bin or other waste receptacle, or otherwise disposed without winding the release liner 15 onto a release liner roll.

A primary advantage of this two-pass embodiment of the invention is that existing high speed labeling machines can be adapted for use with a two-sided labelstock with no, or only minor, modifications to existing equipment. As will be apparent to persons skilled in the art, the two-pass embodiment may be used with other types of existing high speed labeling machines that utilize other label dispensing means (e.g., a vacuum extraction means) instead of a beak 18 to remove the labels from the labelstock. Use of a high speed labeling machine that utilizes a vacuum extraction means to remove the pressure sensitive adhesive labels from the release liner may be particularly advantageous if the second side pressure sensitive adhesive labels would be damaged by being forced to bend around the beak 18 during the first pass of the labelstock through the labeling machine.

### One-Pass Embodiment

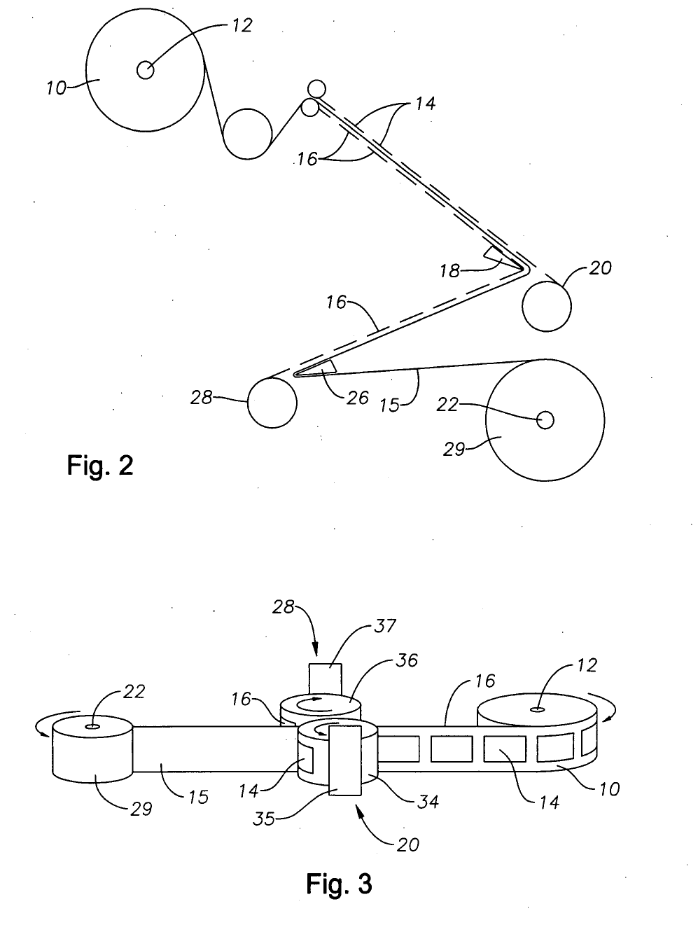

A one-pass embodiment for labeling articles in accordance with the present invention is shown in FIG. 2. According to this embodiment, the method comprises the use of a roll of two-sided labelstock 10 mounted on a label supply means 12 which is rotatably mounted on a high speed labeling machine. The continuous web of two-sided labelstock 10 is fed through the high speed labeling machine toward the first labeling station 20. The release liner material of the two-sided labelstock is somewhat more flexible than the pressure sensitive adhesive labels on both sides thereof. As the two-sided labelstock 10 advances through the machine, the first side pressure sensitive adhesive labels 14 become separated from the release liner material by bending the release liner 15 sharply away from the first side pressure sensitive adhesive labels 14. A first dispensing device, such as a first beak 18, is positioned a spaced distance from the label supply means 12. The spaced distance between the label supply means 12 and the first beak 18 may range from a few inches to many feet. Separation of the first side pressure sensitive adhesive labels 14 is achieved by drawing the two-sided labelstock 10 over the first beak 18. As with the two-pass embodiment discussed above, the end of the first beak 18 should be sufficiently blunt so as to avoid damaging the second side pressure sensitive adhesive labels 16 as they pass over and around the end of the first beak 18.

The less flexible first side pressure sensitive adhesive labels 14 then separate from the release liner 15 and remain relatively straight for application to a plurality of articles by some type of applicator, such as a brush applicator (not shown), at the first labeling station 20. Typically, the articles to be labeled are moving past the first labeling station 20 on some type of conveyor (not shown).

Upon passing over the end of the first beak 18, the release liner 15 with the second side pressure sensitive adhesive labels 16 still intact proceeds toward a second labeling station 28. As before, the less flexible second side pressure sensitive adhesive labels 16 become separated from the release liner material by bending the release liner 15 sharply away from the second side pressure sensitive adhesive labels 16 as they pass over a second beak 26 at a second labeling station 28, which is positioned a spaced distance from the first beak 18. The spaced distance between the first beak 18 and the second beak 26 may range from a few inches to many feet. The second side pressure sensitive adhesive labels 16 remain relatively straight for application to a plurality of articles by some type of application, such as a brush applicator (not shown), at a second labeling station 28. As above, articles are continuously provided to the second labeling station 28 by a conveyor or other handling device (not shown).

Upon passing over the end of the second beak 26, the release liner 15, with pressure sensitive adhesive labels removed from both sides, proceeds toward a release liner rewind means 22 where the release liner 15 is wound onto a release liner roll 29 for convenient disposal. In an alternative embodiment, not shown in FIG. 2, the release liner 15 with both the first side pressure sensitive adhesive labels 14 and the second side pressure sensitive adhesive labels 16 removed may be shredded, spooled onto the floor or other surface, directed into a bin or other waste receptable, or otherwise disposed without winding the release liner 15 onto a release liner roll.

As with the two-pass embodiment described above, persons skilled in the art will recognize that other types of high speed labeling machines that utilize other labeling dispensing means (e.g., vacuum extraction) instead of beaks 18 and 26 may be used for the one-pass embodiment of the present invention. As with the two-pass embodiment, the use of vacuum extract means may be particularly advantageous where the second side pressure sensitive adhesive labels would be damaged by being forced to bend around the first beak 18.

### Device

FIG. 3 illustrates a preferred embodiment of a high speed labeling device for use with a two-sided roll of labelstock according to the present invention. Other high speed labeling machines may also be used, as would be apparent to persons skilled in the art. The high speed labeling device illustrated in FIG. 3 comprises a label supply means 12, a roll of two-sided labelstock 10, a first vacuum drum 34 and a second vacuum drum 36. The device may further comprise a release liner rewind means 22 and release liner roll 29. In a preferred embodiment, the first vacuum drum 34 and the second vacuum drum 36 are located between the label supply means 12 and the release liner rewind means 22. In another embodiment, the first vacuum drum 34 and second vacuum drum 36 are positioned a spaced distance from the label supply means 12. The spaced distance between the label supply means 12 and the first vacuum drum 34 and second vacuum drum 36 may range from a few inches to many feet.

A vacuum is created on the surfaces of the first vacuum drum 34 and second vacuum drum 36 upon contact with the pressure sensitive adhesive labels from each side, respectively, of the two-sided labelstock 10. This vacuum extraction method facilitates the release of the pressure sensitive adhesive labels from the release liner 15 of the two-sided labelstock 10. The pressure sensitive adhesive labels are held in place on the surfaces of the vacuum drums by vacuum. The first vacuum drum 34 rotates in a counter-clockwise direction, thus moving the first side pressure sensitive adhesive label 14 outward, away from the release liner 15 and toward the article 35 to be labeled. The article 35 to be labeled is moved into a position in the first labeling station 20 adjacent to the first vacuum drum 34 by a conveyor or other such means (not shown). Upon contact between the first side pressure sensitive adhesive label 14 and the article 35 to be labeled at the first labeling station 20, the vacuum of the first vacuum drum 34 is released. Alternatively, the strength of the adhesion of the first side pressure sensitive adhesive label 14 to the article 35 is greater than the strength of the vacuum, resulting in the first side pressure sensitive adhesive label 14 transferring from the first vacuum drum 34 to the article 35. The side of the first vacuum drum 34 then serves to place, roll and smooth the pressure sensitive adhesive label 14 onto the surface of the article 35.

The second vacuum drum 36 rotates in a clockwise direction, thus moving the second side pressure sensitive adhesive label 16 (see FIGS. 1 and 2) outward and away from the release liner 15 toward the article 37 to be labeled. The article 37 to be labeled is moved into a position in the second labeling station 28 adjacent to the second vacuum drum 36 by a conveyor or other such means (not shown). Upon contact between the second side pressure sensitive adhesive label 16 and the article 37 to be labeled at the second labeling station 28, the vacuum of the second vacuum drum 36 is released. Alternatively, the strength of the adhesion of the second side pressure sensitive adhesive label 16 to the article 37 is greater than the strength of the vacuum, resulting in the second side pressure sensitive adhesive label 16 transferring from the second vacuum drum 36 to the article 37. The side of the second vacuum drum 36 then serves to place, roll and smooth the second side pressure sensitive adhesive label 16 onto the surface of the article 37.

Preferably, the application of the pressure sensitive adhesive labels to the articles by the first vacuum drum 34 and second vacuum drum 36 occur substantially simultaneously. Thus, first vacuum drum 34 and second vacuum drum 36 are preferably located on opposites sides of the release liner 15 at the same distance along the length of the release liner 15 so that corresponding labels are removed from the opposite sides of the release liner 15 substantially simultaneously. Such an arrangement may facilitate the use of thinner, less expensive release liners since the forces applied to the release liner 15 are opposite and balanced. Alternatively, first vacuum drum 34 and second vacuum drum 36 may be located different distances along the length of the release liner 15 if necessary or desirable for a particular application.

In one embodiment, the release liner 15, with both the first side pressure sensitive adhesive labels 14 and the second side pressure sensitive adhesive labels 16 removed, then travels to a release liner rewind means 22 where the release liner 15 is wound to form a release liner roll 29 for convenient disposal. In an alternative embodiment, not shown in FIG. 3, the release liner 15 with both the first side pressure sensitive adhesive labels 14 and the second side pressure sensitive adhesive labels 16 removed may be shredded, spooled onto the floor or other surface, directed into a bin or other waste receptacle, or otherwise disposed without winding the release liner 15 onto a release liner roll.

In some embodiments of this invention, the pressure sensitive adhesive labels from the first side of the release liner and the pressure sensitive adhesive labels from the second side of the release liner are applied to different articles. The method of application of the labels to the articles may be either a one-pass or two-pass method according to this invention.

In other embodiments of this invention, however, each article receives one pressure sensitive adhesive label from the first side of the release liner at the first labeling station and one pressure sensitive adhesive label from the second side of the release liner at the second labeling station. Typically, the labels would be applied to the articles sequentially according to these embodiments of the invention. For example, an article to be labeled, such as a beverage bottle or other food packaging item, may require the application of a pressure sensitive adhesive label printed with a product name and other marketing information, (the “marketing label”) on one side and a second pressure sensitive adhesive label printed with product ingredients and nutritional information (the “nutritional label”) on the opposite side thereof. The present invention provides a method wherein both the marketing label and the nutritional label are provided on each side, respectively, of the two-sided labelstock for sequential application on a surface or surfaces of the beverage bottle or other food packaging item by a high speed labeling machine.

### INDUSTRIAL APPLICABILITY

The method and device according to the present invention are useful in the high speed labeling of articles.

In one embodiment, the method of labeling articles comprises at least the steps of:

providing a roll of labelstock, the labelstock comprising a release liner having a first side and a second side, and pressure sensitive adhesive labels releasably adhered to both the first side and the second side of the release liner;

providing a plurality of articles to be labeled;

using a high speed labeling machine to remove the pressure sensitive adhesive labels from both the first side and the second side of the release liner and apply the label to the articles.

The method may further comprise the step of using a high speed labeling machine to remove the pressure sensitive adhesive labels from the first side of the release liner and applying each of the pressure sensitive adhesive labels to a different one of the articles during a first pass of the labelstock through the high speed labeling machine; and removing the pressure sensitive adhesive labels from the second side of the release liner and applying each of the pressure sensitive adhesive labels to a different one of the articles during a second pass of the labelstock through the high speed labeling machine.

Additionally, the method may comprise the step of using a high speed labeling machine to remove pressure sensitive adhesive labels from both the first side of the release liner and the second side of the release liner during a single pass of the labelstock through the high speed labeling machine.

Still further, the method may comprise the use of a high speed labeling device, wherein the device comprises:

a label supply means for unwinding a roll of labelstock and feeding the labelstock through the device;

a first vacuum drum including means for removing the pressure sensitive adhesive labels from the first side of the release liner and applying the pressure sensitive adhesive labels to the articles; and

a second vacuum drum including means for removing the pressure sensitive adhesive labels from the second side of the release liner and applying the pressure sensitive adhesive labels to the articles.

The device may further comprise a release liner rewind means for rewinding the release liner after the release liner has passed through the device and the pressure sensitive adhesive labels have been removed from both sides.

The method and device may be used for simultaneous or sequential high speed application of labels from a two-sided labelstock to a variety of articles or goods, such as bottles, jars, food trays, packaging sleeves, cartons, books, magazines, electrical equipment, building products, computer hardware and software, CDs, tapes, stationary, office products, furniture, furnishings, decorative articles, plants, gardening equipment, cleaning and washing products, health and beauty care products, clothing automotive, aerospace and shipping parts and products, mechanical and machine parts, tools, camping, leisure, games and sports equipment, toys, hobby products, food products, boxes and other packaging materials.

The present invention is described herein with reference to one-pass and two-pass high speed labeling machine embodiments. However, various other methods utilizing high speed labeling machines are contemplated. Those skilled in the art will appreciate that numerous modifications to these embodiments may be made without departing from the scope of our invention.

To the extent that this description is specific, it is solely for the purpose of illustrating certain embodiments of the invention and should not be taken as limiting the present inventive concepts to these specific embodiments. Therefore, the spirit and scope of the appended claims should not be limited to the description of the embodiments contained herein.

What is claimed is:

1. A device for labeling articles comprising:
(a) a label supply means for unwinding a roll of labelstock and feeding said labelstock through said device, said roll of labelstock comprising:
(1) a release liner having a first side and a second side, and
(2) pressure sensitive adhesive labels releasably adhered to both said first side and said second side of said release liner;
(b) a first vacuum drum including means for removing said pressure sensitive adhesive labels from said first side of said release liner and applying said pressure sensitive adhesive labels to said articles; and
(c) a second vacuum drum including means for removing said pressure sensitive adhesive labels from said second side of said release liner and applying said pressure sensitive adhesive labels to said articles.

2. The device of claim 1, wherein said device further comprises a release liner rewind means for rewinding said release liner after said release liner has passed through said device and said pressure sensitive adhesive labels have been removed from both sides of said release liner.

3. The device of claim 2, wherein said first vacuum drum and said second vacuum drum are located between said label supply means and said release liner rewind means.

4. The device of claim 1, wherein each of said pressure sensitive adhesive labels from said first side of said release liner and from said second side of said release liner is applied to a different one of said articles.

5. The device of claim 1, wherein each of said articles receives one pressure sensitive adhesive label from said first side of said release liner and one pressure sensitive adhesive label from said second side of said release liner.

6. The device of claim 1, wherein said first vacuum drum and said second vacuum drum are located adjacent to one another whereby corresponding labels from said first side of said release liner and said second side of said release liner are removed from said release liner substantially simultaneously.

7. The device of claim 1, wherein said first vacuum drum and said second vacuum drum remove said pressure sensitive adhesive labels from said first side and said second side of said release liner by means of vacuum extraction.

8. The device of claim 1, wherein said articles to be labeled are selected from the group consisting of bottles, jars, food trays, packaging sleeves, cartons, books, magazines, electrical equipment, building products, computer hardware and software, CDs, tapes, stationary, office products, furniture, furnishings, decorative articles, plants, gardening equipment, cleaning and washing products, health and beauty care products, clothing, automotive, aerospace and shipping parts and products, mechanical and machine parts, tools, camping, leisure, games and sports equipment, toys, hobby products, food products, boxes and other packaging materials.
